(19) United States
(12) Patent Application Publication
(10) Pub. No.: US 2020/0400708 A1
(43) Pub. Date: Dec. 24, 2020

(54) PIEZOELECTRIC SENSOR

(71) Applicant: FATRI (Xiamen) Technologies Co., Ltd., Xiamen City (CN)

(72) Inventor: Ying GAO, Xiamen City (CN)

(73) Assignee: FATRI (Xiamen) Technologies Co., Ltd., Xiamen City (CN)

(21) Appl. No.: 16/658,308

(22) Filed: Oct. 21, 2019

(30) Foreign Application Priority Data
Jun. 21, 2019 (CN) 201920940504.X

(51) Int. Cl. G01P 15/09; G01P 15/097

(52) U.S. Cl. CPC G01P 15/09; G01P 15/097

(57) ABSTRACT

The present disclosure relates to a piezoelectric sensor, which comprises a charge output element comprising a first end surface and a second end surface opposite to each other in a length direction, and comprising a base and a connecting member extending from the base in a height direction, wherein a piezoelectric member and a mass are sleeved on the connecting member, and are fixed to the connecting member via a pretensioning member; a connector, disposed above the first end surface of the charge output element with a predetermined distance from the first end surface in the length direction, and comprising a connector housing and a conductive terminal, which is inserted into an interior of the connector housing and connected to the connector housing by a first insulating layer; and a case, containing the charge output element and connected with the connector housing and the base.

### CROSS REFERENCE TO RELATED APPLICATION

This application claims priority to Chinese Patent Application No. 201920940504.X, filed on Jun. 21, 2019, which is hereby incorporated by reference in its entirety.

### TECHNICAL FIELD

The present disclosure relates to a technical filed of sensor technologies, and particularly relates to a piezoelectric sensor.

### BACKGROUND

A piezoelectric sensor is used more and more widely for measuring vibration of an object. A piezoelectric acceleration sensor, also known as a piezoelectric accelerometer, is an inertial sensor. The principle of the piezoelectric acceleration sensor is to use a piezoelectric effect of a piezoelectric element. When the piezoelectric accelerometer is vibrated, a force applied to the piezoelectric element by a mass changes. When a frequency of the vibration under measurement is much lower than an inherent frequency of the accelerometer, the change of the force is proportional to an acceleration under measurement.

The piezoelectric acceleration sensor is widely used in systems for detection. How to improve an accuracy of electrical signal transmission and ensure measurement accuracy has become an urgent problem to be solved.

### SUMMARY

Embodiments of the present disclosure disclose a piezoelectric sensor, which comprises a charge output element comprising a first end surface and a second end surface opposite to each other in a length direction, the charge output element comprising a base and a connecting member extending from the base in a height direction, wherein a piezoelectric member and a mass are sleeved on the connecting member, the piezoelectric member and the mass are fixed to the connecting member via a pretensioning member, and the mass is disposed closer to the first end surface relative to the piezoelectric member; a connector, disposed above the first end surface of the charge output element with a predetermined distance from the first end surface in the length direction, wherein the connector comprises a connector housing and a conductive terminal, which is inserted into an interior of the connector housing and connected to the connector housing by a first insulating layer; and a case, provided with openings on both ends and formed as a hollow member having a receiving portion, the charge output element is contained in the receiving portion, wherein one opening end of the case is connected with the connector housing by a second insulating layer, and the other opening end of the case is connected with the base.

According to one aspect of the embodiments of the present disclosure, one end of the connector housing is provided with a thread on an outer surface thereof, and the other end of the connector housing is inserted into an interior of the case; and the end of the connector housing located at the interior of the case is provided with a first wire connection hole, which penetrates the connector housing, and an end of the conductive terminal located at the interior of the case is provided with a second wire connection hole, which penetrates the conductive terminal.

According to one aspect of the embodiments of the present disclosure, the first insulating layer comprises a first insulating ceramic layer and a first glass layer disposed in an axial direction of the conductive terminal and circumferentially surrounding the conductive terminal, and the second insulating layer is disposed circumferentially surrounding the connector housing.

According to one aspect of the embodiments of the present disclosure, an end of the conductive terminal away from the case is provided with an insertion hole extending in an axial direction of the conductive terminal, and a ratio of a length of the insertion hole to a length of the conductive terminal in the axial direction of the conductive terminal is in a range from 2:5 to 1:3; and a ratio of the length of the conductive terminal to a length of the first insulating ceramic layer in the axial direction of the conductive terminal is 1:1.

According to one aspect of the embodiments of the present disclosure, the connecting member is disposed at a center of the base and extends in an axial direction of the base, and the base and the connecting member are integrally formed; the piezoelectric member, the mass and the pretensioning member are disposed sequentially in the axial direction of the base, and circumferentially surrounding the connecting member.

According to one aspect of the embodiments of the present disclosure, the conductive terminal, the first insulating layer, the connector housing, the second insulating layer, the case, the connecting member, the piezoelectric member, the mass, and the pretensioning member are all coaxially disposed.

According to one aspect of the embodiments of the present disclosure, the piezoelectric member has a top end and a bottom end opposite to each other in its axial direction, wherein the top end of the piezoelectric member abuts against the mass via an insulating layer, and the bottom end of the piezoelectric member abuts against the base via an insulating layer; and the piezoelectric member comprises a plurality of piezoelectric ceramic layers stacked one on top of another, wherein an electrode layer is disposed between adjacent two piezoelectric ceramic layers, and adjacent two electrode layers have opposite polarities.

According to one aspect of the embodiments of the present disclosure, the connecting member is provided with a thread on an end away from the base, and a ratio of a length of the thread to a length of the connecting member in an axial direction of the base is in a range from 1:2 to 1:3; and the pretensioning member and the connecting member are screwed together.

According to one aspect of the embodiments of the present disclosure, the piezoelectric sensor further comprises a shielding cover having an opening at one end; the base is provided with a shielding cover mounting groove and a case mounting groove coaxially with the connecting member, the connecting member is disposed on an inner side of the shielding cover mounting groove, and the shielding cover mounting groove is disposed on an inner side of the case mounting groove; the opening end of the shielding cover is connected with the shielding cover mounting groove to form a shield having a receiving space therein, and the connecting member, the piezoelectric member, the mass and the pretensioning member are all located within the shield, wherein the shielding cover is provided with a through hole at an end away from the base, and a first wire and a second wire provided on the piezoelectric member can pass through the through hole, and are respectively electrically connected to the connector housing and the conductive terminal; and the opening end of the case away from the connector is connected to the case mounting groove, and the shield is located at an interior of the case.

According to one aspect of the embodiments of the present disclosure, the shielding cover mounting groove has a cross section in a “L” shape, a “V” shape or a trapezoid shape, and the case mounting groove has a cross section in a “L” shape, a “V” shape or a trapezoid shape.

In the piezoelectric sensor according to the embodiments of the present disclosure, the connector and the conductive terminal are insulated by the first insulating layer, and when the piezoelectric member transfers electric charge to the conductive terminal of the connector, the electrical signal of the charge output element is output. The second insulating layer is disposed between the connector housing and the sensor case, to insulate the connector housing and the case of the piezoelectric sensor from each other. As a result, when the charge output element is grounded via the connector housing, the potential of the sensor case can be avoided from affecting the grounding end of the charge output element, thereby improving the measurement accuracy of the piezoelectric acceleration sensor.

### BRIEF DESCRIPTION OF THE DRAWINGS

The drawings accompanied by the embodiments of the present disclosure will be briefly described below, and other drawings can be obtained by the person skilled in the art without any creative work.

In order to more clearly illustrate the technical solutions of the embodiments of the present disclosure, the accompanying drawings used in the embodiments of the present disclosure will be briefly introduced. For the person skilled in the art, other drawings can be obtained from these drawings without expending any creative labors.

FIG. 1 is a perspective view of a piezoelectric sensor according to an embodiment of the present disclosure;

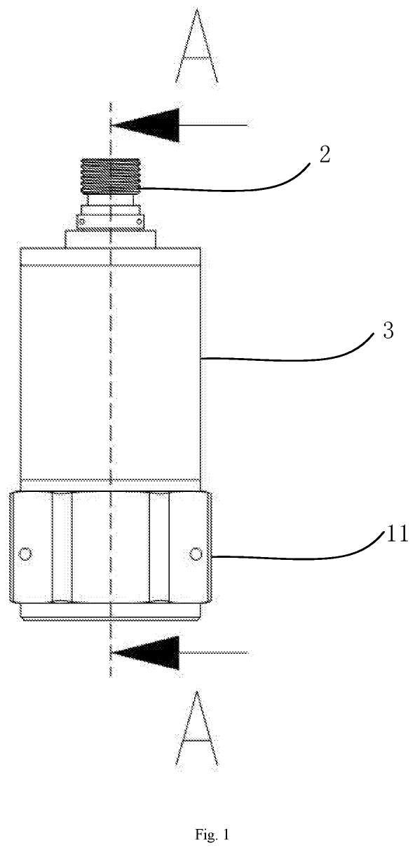

FIG. 2 is a cross-sectional view of a piezoelectric sensor A-A according to an embodiment of the present disclosure;

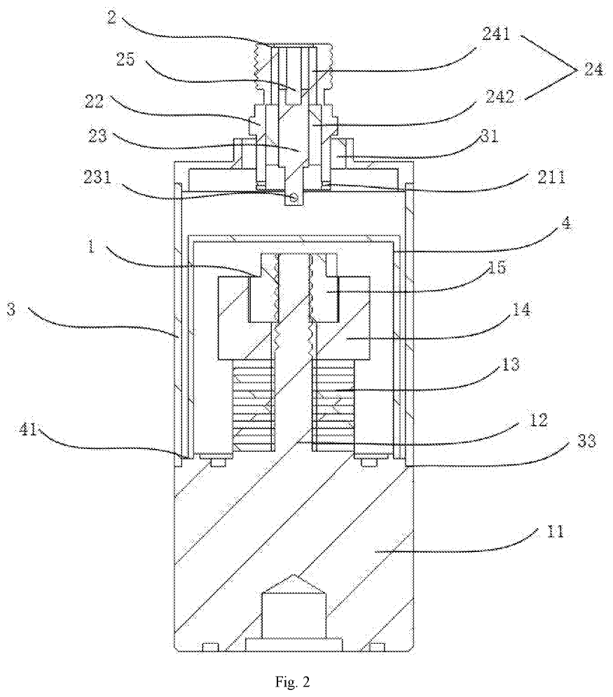

FIG. 3 is a perspective view of a piezoelectric sensor according to an embodiment of the present disclosure.

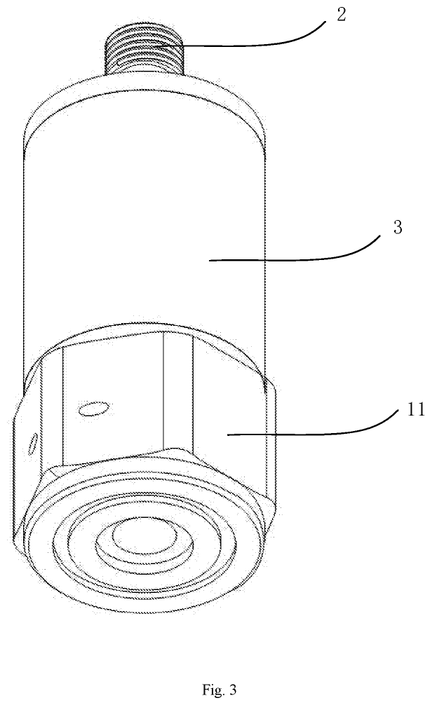

### REFERENCE NUMERALS

1—charge output element; 11—base; 12—connector; 13—piezoelectric member; 14—mass; 15—pretensioning member; 2—connector; 22—connector housing; 211—first wire connection hole; 23—conductive terminal; 231—second wire connection hole; 24—first insulating layer; 241—first insulating ceramic layer; 242—first glass layer; 25—insertion hole; 3—case; 31—second insulating layer; 33—case mounting groove; 4—shield; 41—shielding cover mounting groove.

### DETAILED DESCRIPTION

Below, various aspects and exemplary embodiments of the present disclosure will be described in detail. In order to clearly show the objects, technical solutions and advantages of the present disclosure, the present disclosure is further described in detail below with reference to the drawings and embodiments. It should be understood that, the described embodiments are intended to explain the present disclosure, exemplarily illustrate principles of the present disclosure and are not intended to limit the scope of the present disclosure. For the person skilled in the art, the present disclosure may be practiced without some of the details of these specific details. The following description of the embodiments is merely used to provide a better understanding of the present disclosure in a manner of illustrating examples of the present disclosure.

It should be noted that, in this context, relational terms such as “first” and “second” are used merely to distinguish one entity or operation from another entity or operation, and do not necessarily require or imply any actual relationship or order between the entities or operations. Further, terms “comprise”, “include” or any other variations thereof are intended to encompass a non-exclusive inclusion, such that a process, method, article, or device including a plurality of elements, includes not only the plurality of elements, but also other elements not specifically listed, or other elements that are inherent to such a process, method, article, or device. The element that is defined by the phrase “comprises” without other limitations, does not exclude the presence of additional identical elements in the process, method, article, or device including this element.

In order to solve the problem in prior art, an embodiment of the present disclosure discloses a piezoelectric sensor including a charge output element 1, which includes a first end surface and a second end surface opposite to each other in a length direction. The charge output element 1 includes a base 11 and a connecting member 12 extending from the base 11 in a height direction. A piezoelectric member 13 and a mass 14 are sleeved on the connecting member 12. The piezoelectric member 13 and the mass 14 are fixed to the connecting member 12 by a pretensioning member 15, and the mass 14 is disposed closer to the first end surface relative to the piezoelectric member 13. The piezoelectric sensor further includes a connector 2, which is disposed above the first end surface of the charge output element 1 with a predetermined distance from the first end surface in the length direction. The connector 2 includes a connector housing 22 and a conductive terminal 23 inserted into an interior of the connector housing 22. The connector housing 22 and the conductive terminal 23 are connected by a first insulating layer 24. The piezoelectric sensor further includes a case 3, which is formed as a hollow member and includes openings on both ends and a receiving portion for containing the charge output element 1. One opening end of the case 3 is connected to the connector housing 22 by a second insulating layer 31, and the other opening end of the case 3 is connected to the base 11.

Specifically, the one opening end of the case 3 is connected with the connector housing 22 by the second insulating layer 31, and the other opening end of the case 3 is connected with the base 11. The connector 2 includes the connector housing 22 and the conductive terminal 23 inserted into the interior of the connector housing 22, and the first insulating layer 24 is disposed between the connector housing 22 and the conductive terminal 23. The first insulating layer 24 is disposed in an axial direction of the conductive terminal 23. The insulating layer 24 includes a first insulating ceramic layer 241 and a first glass layer 242 sequentially disposed in the axial direction of the conductive terminal 23, and the first glass layer 242 is located closer to the charge output element 1. The connector housing 22 has an inner surface facing the conductive terminal 23 and an outer surface facing away from the conductive terminal 23, and the first insulating ceramic layer 241 has an inner surface facing the conductive terminal 23 and an outer surface facing away from the conductive terminal 23, wherein the inner surface of the first insulating ceramic layer 241 is fitted to the conductive terminal 23, and the outer surface of the first insulating ceramic layer 241 is fitted to the inner surface of the connector housing 22. The first glass layer 242 has an inner surface facing the conductive terminal 23 and an outer surface facing away from the conductive terminal 23, wherein the inner surface of the first glass layer 242 is fitted to the conductive terminal 23, and the outer surface of the first glass layer 242 is fitted to the inner surface of the connector housing 22. The connector housing 22 and the conductive terminal 23 are insulated from each other by the first insulating layer 24. When the piezoelectric member 13 transfers electric charge to the conductive terminal 23 of the connector 2, an output of an electrical signal of the charge output element 1 is realized. The second insulating layer 31 is disposed between the connector housing 22 and the sensor case 3, thereby ensuring an insulation between the connector housing 22 and the case 3 of the piezoelectric sensor. The piezoelectric member 13 is further electrically connected to the connector housing 22, to realize the grounding of the charge output element 1 via the connector housing 22. The second insulating layer 31 can prevent the grounding end of the charge output element 1 from being affected by a potential of the sensor case 3, thereby improving a measurement accuracy of the piezoelectric acceleration sensor.

Further, the inner surface of the first glass layer 242 is sintered to the conductive terminal 23, and the outer surface of the first glass layer 242 is sintered to the connector housing 22. The inner surface of the first insulating ceramic layer 241 is sintered to the conductive terminal 23, and the outer surface of the insulating ceramic layer 241 is sintered to the inner surface of the connector housing 22. The inner surface of the second insulating layer 31 is sintered the outer surface of the connector housing 22.

Further, the base 11 has an axial direction coinciding with or parallel to the axial direction of the conductive terminal 23, and the length direction of the charge output element 1 is the same as the axial direction of the base 11.

In some alternative embodiments, one end of the connector housing 22 is provided with a thread on the outer surface thereof, and the other end of the connector housing 22 is inserted into an interior of the case 3. The end of the connector housing 22 located in the interior of the case 3 is provided with a first wire connection hole 211, which penetrates the connector housing 22 the connector housing 22. An end of the conductive terminal 23 located in the interior of the case 3 is provided with a second wire connection hole 231, which penetrates the conductive terminal 23 the conductive terminal 23.

Specifically, one of two electrodes of the piezoelectric member 13 is connected to the conductive terminal 23 of the connector 2, to realize the output of the electrical signal of the charge output element 1. The other of the two electrodes of the piezoelectric member 13 is connected to the housing of the connector 2, which is insulated from the case 3 of the piezoelectric sensor. As a result, the grounding of the charge output element 1 can be realized by the housing of the connector 2, and also can be prevented from being affected by the potential of the case 3, thereby ensuring the measurement accuracy of the piezoelectric acceleration sensor. The first wire connection hole 211 is used for connecting a first wire, and the second wire connection hole 231 is used for connecting the second wire. The piezoelectric member 13 is connected to the connector housing 22 via the first wire, and the piezoelectric member 13 is connected to the conductive terminal 23 via the second wire.

In some alternative embodiments, the first insulating layer 24 includes the first insulating ceramic layer 241 and the first glass layer 242 disposed in the axial direction of the conductive terminal 23, and the first insulating ceramic layer 241 and the first glass layer 242 are both disposed circumferentially surrounding the conductive terminal 23. The second insulating layer 31 is disposed circumferentially surrounding the connector housing 22.

In some alternative embodiments, an end of the conductive terminal 23 away from the case 3 is provided with an insertion hole 25 extending in the axial direction of the conductive terminal 23. A ratio of a length of the insertion hole 25 to a length of the conductive terminal 23 in the axial direction is in a range from 2:5 to 1:3; and a ratio of the length of the conductive terminal 23 to a length of the first insulating ceramic layer 241 in the axial direction of the conductive terminal is in a range from 1:1 to 2:1.

Alternatively, the ratio of the length of the insertion hole 25 to the length of the conductive terminal 23 in the axial direction of the conductive terminal is 1:3; and the ratio of the length of the conductive terminal 23 to the length of the first insulating ceramic layer 241 in the axial direction of the conductive terminal is 1:1.

Specifically, the insertion hole 25 is used for connecting with an insert, and the insert is connected to a device under test. The ratio of the length of the insertion hole 25 to the length of the conductive terminal 23 in the axial direction of the conductive terminal is in the range from 2:5 to 1:3, which can ensure good electrical contact between the device under test and the piezoelectric sensor, and thus ensure the measurement accuracy of the piezoelectric sensor.

In some alternative embodiments, the connecting member 12 is disposed at a central position of the base 11 and extends in the axial direction of the base 11, and the base 11 and the connecting member 12 are integrally formed. The piezoelectric member 13, the mass 14 and the pretensioning member 15 are disposed sequentially in the axial direction of the base 11 and circumferentially surrounding the connecting member 12.

In some alternative embodiments, the conductive terminal 23, the first insulating layer 24, the connector housing 22, the second insulating layer 31, the case 3, the connector 12, the piezoelectric member 13, the mass 14 and the pretensioning member 15 are all disposed coaxially.

Further, the piezoelectric member 13 has a top end and a bottom end opposite to each other in an axial direction of the piezoelectric member 13, wherein the top end of the piezoelectric member 13 abuts against the mass 14 via an insulating layer, and the bottom end of the piezoelectric member 13 abuts against the base 11 via an insulating layer. The piezoelectric member 13 includes a plurality of piezoelectric ceramic layers stacked one on top of another, wherein an electrode layer is disposed between adjacent two piezoelectric ceramic layers, and adjacent two electrode layers have opposite polarities. The piezoelectric member 13 is provided with a central through hole, and the connecting member 12 is connected to the the piezoelectric member 13 by passing through the central through hole. A wall of the central through hole of the piezoelectric member 13 is insulated from, for example, gap-fitted with the connecting member 12. The mass 14 is provided with a central hole, through which the connecting member 12 passes and is connected to the mass 14, and a wall of the central hole of the mass 14 is insulated from, for example, gap-fitted with the connecting member 12.

In some alternative embodiments, the connecting member 12 is provided with a thread on one end away from the base 11, and a ratio of a length of the thread to a length of the connecting member 12 in an axial direction of the connecting member 12 is in a range from 1:2 to 1:3. The pretensioning member 15 and the connecting member 12 are screwed together.

Alternatively, the ratio of the length of the thread to the length of the connecting member 12 in the axial direction of the connecting member is 1:3.

The external thread of the connector 2 is used to connect with the insert. The insert includes a pin, a pin housing surrounding the pin, and a wire connected with the device under test. The pin housing is provided with a thread on an inner wall. When the pin is inserted into the insertion hole 25 of the conductive terminal 23, the pin housing and the connector housing 22 are connected, and the piezoelectric sensor can be easily detached from the device under test.

In some alternative embodiments, the piezoelectric sensor further includes a shielding cover 4 that is open at one end. The base 11 is provided with a shielding cover mounting groove 41 and a case mounting groove 33 coaxially with the connecting member 12. The connecting member 12 is disposed on an inner side of the shielding cover mounting groove 41, and the shielding cover mounting groove 41 is disposed on an inner side of the case mounting groove 33. The opening end of the shielding cover 4 is connected to the shielding cover mounting groove 41, to form a shield having a receiving space therein, and the connecting member 12, the piezoelectric member 13, the mass 14 and the pretensioning member 15 are all located within the shield. The shielding cover 4 is provided with a through hole at one end away from the base 11, and both of the first wire and the second wire provided on the piezoelectric member 13 can pass through the through hole, and are electrically connected to the connector housing 22 and the conductive terminal 23 respectively. The opening end of the case 3 away from the connector 2 is connected to the case mounting groove 33, and the shield is located at an interior of the case 3.

In some alternative embodiments, the shielding cover mounting groove 41 has a cross section in a “L” shape, a “V” shape or a trapezoid shape, and the case mounting groove 33 has a cross section in a “L” shape, a “V” shape or a trapezoid shape.

Specifically, the cross section of the shielding cover mounting groove 41 in the axial direction of the base is in the “L” shape, the “V” shape or the trapezoid shape, and the cross-section of the case mounting groove 33 in the axial direction of the base is in the “L” shape, the “V” shape or the trapezoid shape.

In the above description, merely specific embodiments of the present disclosure are described. It should be understood that, the protective scope of the present disclosure is not limited thereto, and the person skilled in the art can easily conceive various equivalent modifications or replacements within the technical scope disclosed by the present disclosure, which also fall within the protective scope of the present disclosure.

What is claimed is:

1. A piezoelectric sensor, comprising:
a charge output element comprising a first end surface and a second end surface opposite to each other in a length direction, the charge output element comprising a base and a connecting member extending from the base in a height direction, wherein a piezoelectric member and a mass are sleeved on the connecting member, the piezoelectric member and the mass are fixed to the connecting member via a pretensioning member, and the mass is disposed closer to the first end surface relative to the piezoelectric member;
a connector, disposed above the first end surface of the charge output element with a predetermined distance from the first end surface in the length direction, wherein the connector comprises a connector housing and a conductive terminal, which is inserted into an interior of the connector housing and connected to the connector housing by a first insulating layer; and
a case, provided with openings on both ends and formed as a hollow member having a receiving portion, the charge output element is contained in the receiving portion, wherein one opening end of the case is connected with the connector housing by a second insulating layer, and the other opening end of the case is connected with the base.

2. The piezoelectric sensor according to claim 1, wherein:
one end of the connector housing is provided with a thread on an outer surface thereof, and the other end of the connector housing is inserted into an interior of the case; and
the end of the connector housing located at the interior of the case is provided with a first wire connection hole, which penetrates the connector housing, and an end of the conductive terminal located at the interior of the case is provided with a second wire connection hole, which penetrates the conductive terminal.

3. The piezoelectric sensor according to claim 1, wherein the first insulating layer comprises a first insulating ceramic layer and a first glass layer disposed in an axial direction of the conductive terminal and circumferentially surrounding the conductive terminal, and the second insulating layer is disposed circumferentially surrounding the connector housing.

4. The piezoelectric sensor according to claim 1, wherein:
an end of the conductive terminal away from the case is provided with an insertion hole extending in an axial direction of the conductive terminal, and a ratio of a length of the insertion hole to a length of the conductive terminal in the axial direction of the conductive terminal is in a range from 2:5 to 1:3; and
a ratio of the length of the conductive terminal to a length of the first insulating ceramic layer in the axial direction of the conductive terminal is 1:1.

5. The piezoelectric sensor according to claim 1, wherein:
the connecting member is disposed at a center of the base and extends in an axial direction of the base, and the base and the connecting member are integrally formed;
the piezoelectric member, the mass and the pretensioning member are disposed sequentially in the axial direction of the base, and circumferentially surrounding the connecting member.

6. The piezoelectric sensor according to claim 1, wherein the conductive terminal, the first insulating layer, the connector housing, the second insulating layer, the case, the connecting member, the piezoelectric member, the mass, and the pretensioning member are all coaxially disposed.

7. The piezoelectric sensor according to claim 1, wherein:
the piezoelectric member has a top end and a bottom end opposite to each other in its axial direction, wherein the top end of the piezoelectric member abuts against the mass via an insulating layer, and the bottom end of the piezoelectric member abuts against the base via an insulating layer; and
the piezoelectric member comprises a plurality of piezoelectric ceramic layers stacked one on top of another, wherein an electrode layer is disposed between adjacent two piezoelectric ceramic layers, and adjacent two electrode layers have opposite polarities.

8. The piezoelectric sensor according to claim 1, wherein:
the connecting member is provided with a thread on an end away from the base, and a ratio of a length of the thread to a length of the connecting member in an axial direction of the base is in a range from 1:2 to 1:3; and
the pretensioning member and the connecting member are screwed together.

9. The piezoelectric sensor according to claim 1, further comprising:
a shielding cover having an opening at one end;
the base is provided with a shielding cover mounting groove and a case mounting groove coaxially with the connecting member, the connecting member is disposed on an inner side of the shielding cover mounting groove, and the shielding cover mounting groove is disposed on an inner side of the case mounting groove;
the opening end of the shielding cover is connected with the shielding cover mounting groove to form a shield having a receiving space therein, and the connecting member, the piezoelectric member, the mass and the pretensioning member are all located within the shield, wherein the shielding cover is provided with a through hole at an end away from the base, and a first wire and a second wire provided on the piezoelectric member can pass through the through hole, and are respectively electrically connected to the connector housing and the conductive terminal; and
the opening end of the case away from the connector is connected to the case mounting groove, and the shield is located at an interior of the case.

10. The piezoelectric sensor according to claim 9, wherein the shielding cover mounting groove has a cross section in a “L” shape, a “V” shape or a trapezoid shape, and the case mounting groove has a cross section in a “L” shape, a “V” shape or a trapezoid shape.
